(19) United States
(12) Patent Application Publication
(10) Pub. No.: US 2023/0147944 A1
(43) Pub. Date: May 11, 2023

(54) PUSHER LIFT CART

(71) Applicant: Cemen Tech, Inc., Indianola, IA (US)

(72) Inventors: Thomas George, Indianola, IA (US); Bryan Benes, Indianola, IA (US)

(21) Appl. No.: 18/054,336

(22) Filed: Nov. 10, 2022

Related U.S. Application Data
(60) Provisional application No. 63/277,904, filed on Nov. 10, 2021.

(51) Int. Cl. B62B 3/06; B62B 3/00; B62B 5/00

(52) U.S. Cl. CPC B62B 3/0612; B62B 3/008; B62B 5/0033; B62B 5/0079; B62B 2203/10

(57) ABSTRACT

Disclosed is a pusher lift cart comprising a pusher lift cart main frame having a first interfacing member and a second interfacing member configured to telescoping engage a first complementary interfacing member and a second complementary interfacing member, wherein the pusher cart main frame is configured to receive and move an axle.

### CROSS REFERENCE TO RELATED APPLICATION

This application claims the benefit of U.S. Provisional Pat. Application No. 63/277,904 filed with the United States Patent and Trademark Office on Nov. 10, 2021, the entire contents of which is herein incorporated by reference.

### BACKGROUND

### 1. Field

Example embodiments relate to a pusher lift cart and methods of using the same.

### 2. Description of the Related Art

Pusher lift carts are well known in the art and are used to move a variety of items. Quite often the lift carts use a scissors jack type of apparatus to move a cart bed upwards and downwards. Other lift carts use actuators, for example, pneumatic, electric, or hydraulic cylinders to lift the cart bed upwards and downwards.

### SUMMARY

The inventor notes movement of axles can be quite difficult using conventional lift carts. Thus, in order to improve over the prior art, the inventor invented a new type of pusher lift cart having, amongst other things, a profile allowing axles be supported near the ground on which the pusher lift cart rests. An example of the pusher lift cart includes one or more actuators allowing an axle to be raised and lowered. In one nonlimiting example embodiment, a pusher lift cart includes two actuators allowing ends of the axle to be moved upwards and downwards. The two actuators may be operated independently of one another allowing the axle to be tilted, if so desired. In another embodiment the actuators are moved in a synchronous manner so that ends of the axle may be raised and/or lowered at the same time and at the same rate.

Disclosed is a pusher lift cart comprising a pusher lift cart main frame having first a first end and a second end, a first top section at the first end, a second top section at the second end, a first interfacing member on the first top section, a second interfacing member on the second top section, and an axle support section between the first top section and the second top section. The pusher lift car further includes a first pusher lift cart sub frame at the first end of the pusher lift cart main frame, the first pusher lift cart subframe having a first complementary interfacing member telescopingly engaged with the first interfacing member, and a second pusher lift cart sub frame at the second end of the pusher lift cart main frame, the second pusher lift car subframe having a second complementary interfacing member telescopingly engaged with the second interfacing member. The pusher lift car further includes a first actuator connected to the first top section and the first pusher lift cart subframe and a second actuator connected to the second top section and the second pusher lift cart subframe, wherein the first end and the second end of the pusher lift cart main frame are moved upwards and downwards by the first and second actuators.

### BRIEF DESCRIPTION OF THE DRAWINGS

Example embodiments are described in detail below with reference to the attached drawing figures, wherein:

FIG. 1 is a perspective view of a pusher lift cart in accordance with an example embodiment;

FIG. 2 is a top view of the pusher lift cart in accordance with an example embodiment;

FIG. 3 is a front view of the pusher lift cart in accordance with an example embodiment;

FIG. 4 is a section view of the pusher lift cart in accordance with an example embodiment;

FIG. 5 is an end view of the pusher lift cart in accordance with an example embodiment;

FIG. 6 is an exploded view of the pusher lift cart in accordance with an example embodiment;

FIG. 7 is a perspective view of a pusher lift cart main frame in accordance with an example embodiment;

FIG. 8 is a top view of the pusher lift cart main frame in accordance with an example embodiment;

FIG. 9 is a front view of the pusher lift cart main frame in accordance with an example embodiment;

FIG. 10 is a section view of the pusher lift cart main frame in accordance with an example embodiment;

FIG. 11 is a bottom view of the pusher lift cart main frame in accordance with an example embodiment;

FIG. 12 is a bottom/closeup view of the pusher lift cart main frame in accordance with an example embodiment;

FIG. 13 is a perspective view of a pusher lift cart subframe in accordance with an example embodiment;

FIG. 14 is a top view of the pusher lift cart subframe in accordance with an example embodiment;

FIG. 15 is a front view of the pusher lift cart subframe in accordance with an example embodiment;

FIG. 16 is a bottom view of the pusher lift cart subframe in accordance with an example embodiment;

FIG. 17 is a side view of the pusher lift cart subframe in accordance with an example embodiment;

FIG. 18 is a perspective view of a pusher cradle insert in accordance with an example embodiment;

FIG. 19 is a perspective view of a lower backer plate in accordance with an example embodiment;

FIG. 20 is a perspective view of an actuator mounting ear in accordance with an example embodiment;

FIG. 21 is a perspective view of a subframe tow plate in accordance with an example embodiment;

FIG. 22 is a view of a pusher lift cart supporting an axle in accordance with an example embodiment; and

FIG. 23 is a view is a view of a pusher lift cart supporting an axle in accordance with an example embodiment.

### DETAILED DESCRIPTION

Example embodiments will now be described more fully with reference to the accompanying drawings. Example embodiments are not intended to limit the disclosure since the disclosure may be embodied in different forms. Rather, example embodiments are provided so that this disclosure will be thorough and complete, and will fully convey the scope of the disclosure to those skilled in the art. In the drawings, the sizes of components may be exaggerated for clarity.

In this application, when a first element is described as being “on” or “connected to” a second element, the first element may be directly on or directly connected to the second element or may be on or connected to an intervening element that may be present between the first element and the second element. When a first element is described as being “directly on” or “directly connected to” a second element, there are no intervening elements. In this application, the term “and/or” includes any and all combinations of one or more of the associated listed items.

In this application, spatially relative terms merely describe one element’s relationship to another. The spatially relative terms are intended to encompass different orientations of the structure. For example, if a first element of a structure is described as being “above” a second element, the term “above” is not meant to limit the disclosure since, if the structure is turned over, the first element would be “beneath” the second element. As such, use of the term “above” is intended to encompass the terms “above” and “below”. The structure may be otherwise oriented (rotated 90 degrees or at other orientations) and the spatially relative descriptors used herein interpreted accordingly.

Example embodiments are illustrated by way of ideal schematic views. However, example embodiments are not intended to be limited by the ideal schematic views since example embodiments may be modified in accordance with manufacturing technologies and/or tolerances.

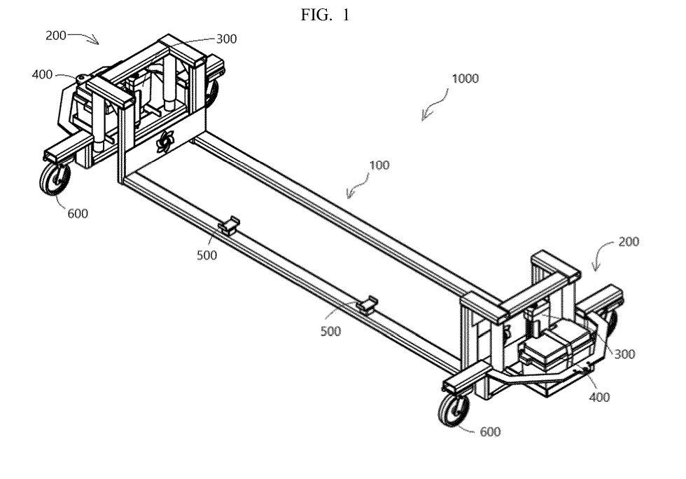

FIG. 1 is a view of a pusher lift cart 1000 in accordance with an example embodiment. The pusher lift cart 1000 of this example embodiment includes a pusher lift cart main frame 100 supported by a pair of pusher cart subframes 200. The pusher cart subframes 200 include actuators 300 configured to move ends of the pusher lift cart main frame 100. In one nonlimiting example embodiment the actuators 300 may be powered by a power source 400. For example, the actuators 300 may be, but are not required to be, electrically powered linear actuators and the power source 400 may be a battery, for example, a 12 VDC battery. In FIG. 1, the subframes 200 are supported by one or more castor wheels 600, however, other types of supports are envisioned. For example, rather than castor wheels 600, the subframes 200 may be supported by skids or tractors. In example embodiments, the pusher lift cart 1000 may include one or more cradle inserts 500 to support an axle. The cradle inserts 500 may be part of, or associated with, the pusher lift cart main frame 100.

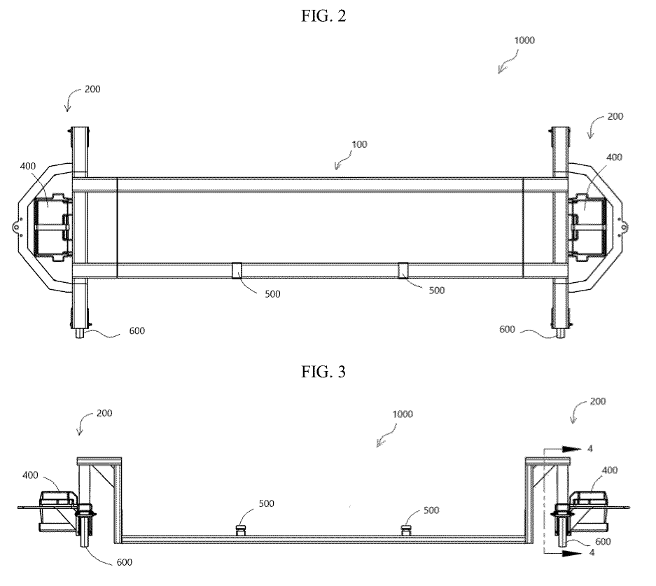

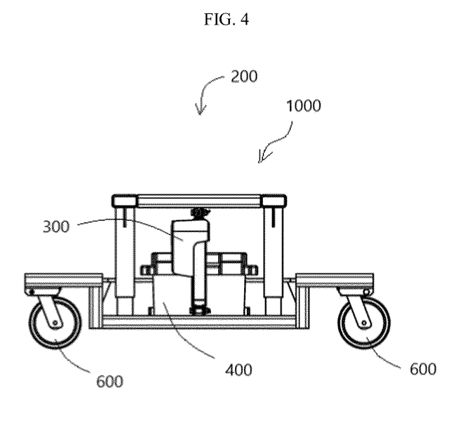

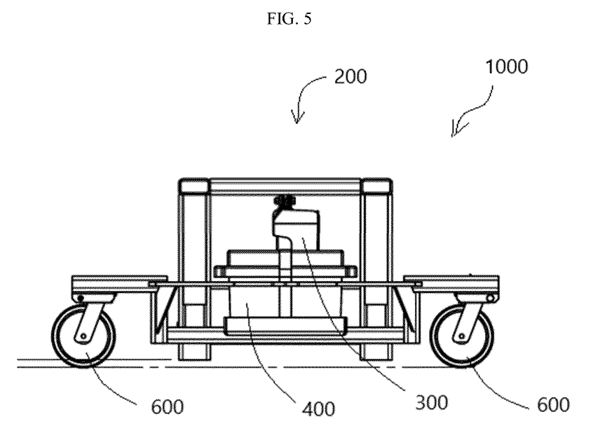

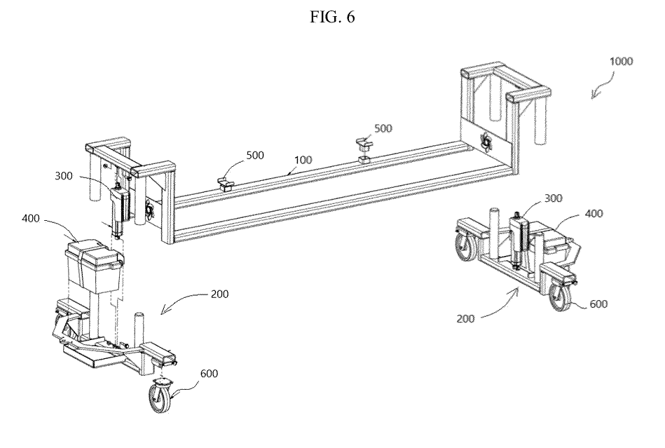

FIGS. 2-6 show various views of the pusher lift cart 1000. For example, FIG. 2 is a top view of the pusher lift cart 1000, FIG. 3 is a front view of the pusher lift cart 1000, FIG. 4 is a section view of the pusher lift cart 1000 taken through section line 4-4 of FIG. 3, FIG. 5 is an end view of the pusher lift cart 1000, and FIG. 6 is an exploded view of the pusher lift cart 1000. Because these views are self-explanatory, a detailed description thereof is omitted for the sake of brevity. Hereinafter a description of the various components of the pusher lift cart 1000 are described.

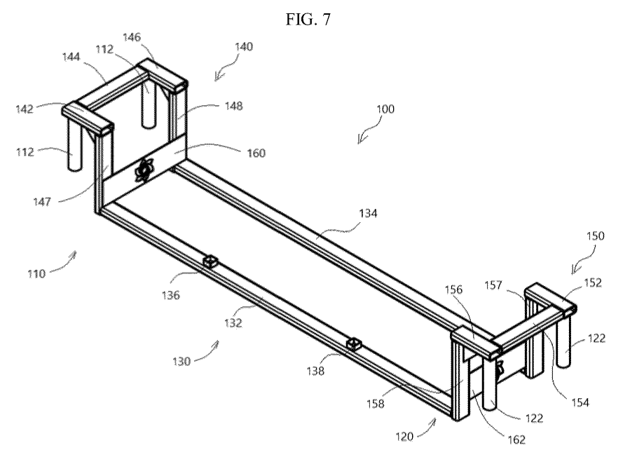

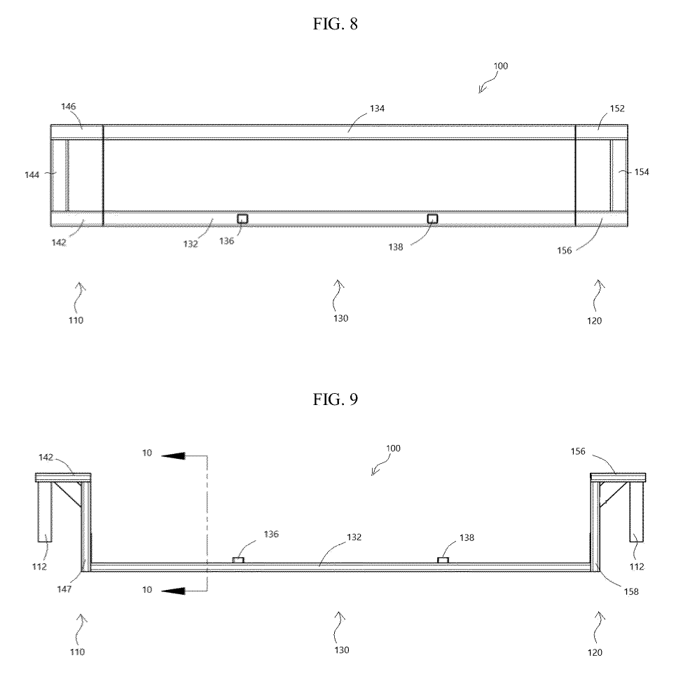

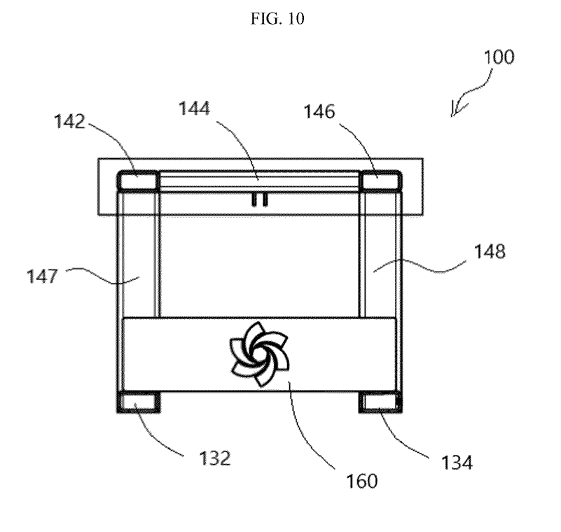

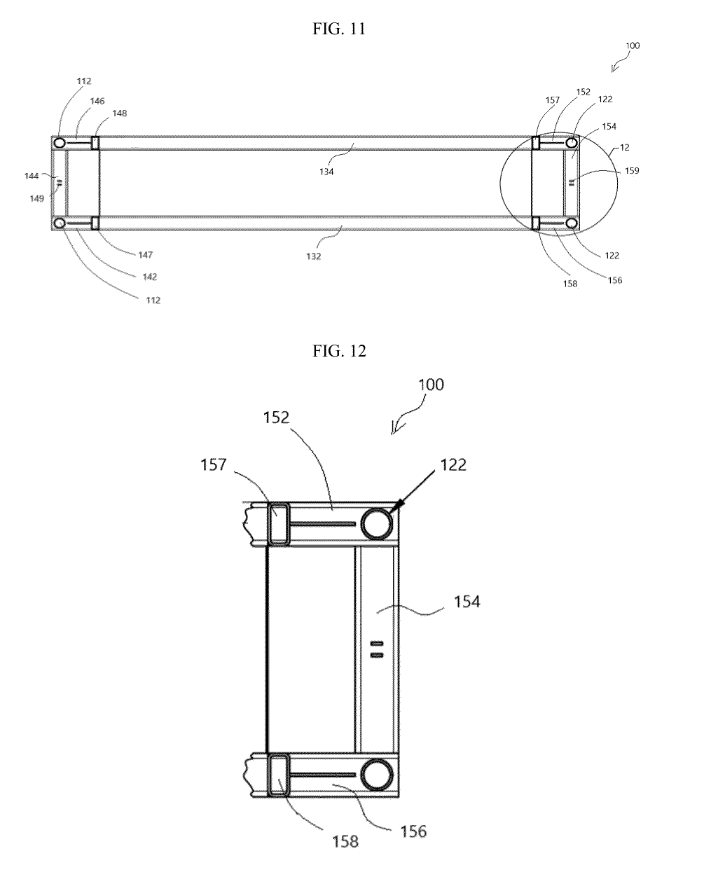

FIG. 7 is a view of the pusher lift cart main frame 100. In the nonlimiting example of FIG. 7, the pusher lift cart main frame 100 has a first end 110 and a second end 120 with an axle support section 130 between the first end 110 and the second end 120. As shown in at least FIG. 7, the axle support section 130 may have one or more cradle side plates 136 and 138 which may be configured to receive a cradle inserts 500. The cradle inserts 500, as will be explained, may support an axle.

In example embodiment, the first end 110 of the pusher lift cart main frame 100 may have a transition section and a top section 140. Similarly, the second end 120 of the pusher lift cart main frame 100 may also have a transition section and a top section 150. The transition section at the first end 110 of the pusher lift cart main frame 100 is shown as being comprised of a first straight vertical member 147 and a second straight vertical member 148, however, this example is merely for the purpose of illustration and not meant to limit the invention. For example, the transition section may be comprised of straight inclined members or curved members instead. Similarly, the transition section at the second end 120 of the pusher lift cart main frame 100 may also be comprised a first straight vertical member 157 and a second straight vertical member 158, however, this example is also merely for the purpose of illustration and not meant to limit the invention. For example, this transition section may be comprised of straight inclined members or curved members instead.

Referring again to FIG. 7, the top section 140 may include interfacing members 112 which may be configured to interface with complementary interfacing members 212 of the pusher lift cart subframe 200. For example, in one nonlimiting embodiment, the interfacing members 112 and the complementary interfacing members 212 may resemble tubes or cylinders which engage each other in a telescoping manner. For example, the interfacing members 112 may resemble hollow cylinders and the complementary interfacing members 212 may resemble cylindrical tubes or posts insertable into the interfacing members 112. In the alternative, the interfacing members 112 may resemble cylinders and the complementary interfacing members 212 may resemble hollow cylindrical tubes into which the interfacing members 112 may insert. Of course, the interfacing members 112 and complementary interfacing members 212 are not required to be cylindrical, for example, in another embodiment they may resemble square or rectangular tubes that engage each other in a telescoping manner.

The above teachings may also be pertinent to second end 120 of the pusher lift car main frame 100. For example, the top section 150 may include interfacing members 122 which may be configured to interface with complementary interfacing members 212 of another pusher lift cart subframe 200. For example, in one nonlimiting embodiment, the interfacing members 122 and the complementary interfacing members 212 may resemble tubes or cylinders which engage each other in a telescoping manner. For example, the interfacing members 122 may resemble a hollow cylinder and the complementary interfacing members 212 may resemble cylindrical tubes insertable into the interfacing members 122. In the alternative, the interfacing members 122 may resemble cylinders and the complementary interfacing members 212 may resemble hollow cylindrical tubes into which the interfacing members 122 may insert. Of course, the interfacing members 122 and complementary interfacing members 212 are not required to be cylindrical, for example, in another embodiment they may resemble square or rectangular tubes that engage each other in a telescoping manner.

In example embodiments the top sections 140 and 150 may take several forms. In the example shown in the figures, the top sections 140 and 150 are shown as comprised of tube steel. For example, the first top section 140 is comprise of three pieces of tube steel 142, 144 and 146 welded together to form a solid section. Similarly, top section 150 may also be formed from three pieces of tube steel 152, 154, and 156 welded together to form a solid section. However, it is understood this aspect of example embodiments is for purposes of illustration only. For example, rather than forming the top sections 140 and 150 from three pieces of tube steel, a molding or bending process may be employed to produce a section highly similar to the illustrated top sections 140 and 150 comprised of welded together tube steel members.

In example embodiments, the pusher lift cart main frame 100 may also include backer plates 160 and 162. The backer plates may resemble rectangular plates welded to the transition sections (for example, transition members 147, 148, 157 and 158). The backer plates 160 and 162 increase may increase the strength of the pusher lift cart main frame 100 as well as provide stiffness to add stability to the pusher cart main frame 100.

In example embodiments, the axle support section 130 may be configured to support an axle. In the nonlimiting example embodiment of at least FIG. 7, the axle support section 130 may be comprised of a first structural member 132 and a second structural member 134 spaced apart from one another. In the figures the first and second structural members 132 and 134 are illustrated as being comprised of tube steel, however, other types of structural members, for example, W-shapes, H-shapes, or I-shapes are contemplated. In the nonlimiting example of FIG. 7, the first structural member 132 may include a pair of cradle side plates 136 and 138 to accommodate the cradle inserts 500. Though only two cradle side plates 136 and 138 are shown, it is understood there may be more than two. Further, in another embodiment, each of the first and second structural members 132 and 134 include cradle side plates configured to receive a cradle insert 500.

In example embodiments the pusher lift cart main frame 100 is shown as being largely constructed as being made from tube steel. For example, each of members 132, 147, 142, 144, 146, 148, 134, 157, 152, 154, 156, and 158 may be 4×2×¼ tube steel members welded together to form a substantially unitary whole. However, the tube steel size may be different depending on required strength. In addition, rather than using tube steel, other shapes may be used. For example, rather than fabricating members 132, 147, 142, 144, 146, 148, 134, 157, 152, 154, 156, and 158 from 4×2×¼ tube steel, W-shapes, H-shapes, I-shapes, or even C-shapes may be used.

In example embodiments the top section 140 may include a pair of ears 149 on an underside thereof. Similarly, top section 150 may also include a pair of ears 159 on an underside thereof. The ears 149 and 159 (see FIG. 20 for a close-up view of an ear) may facilitate a connection for the actuators 300 to the pusher lift cart main frame 100.

As one skilled in the art will appreciate, the profile of the pusher lift cart main frame 100 has the axle support section 130 at a lower elevation than top sections 140 and 150. As will be explained shortly, this arrangement will help facilitate keeping the axle support section 130 relatively close to the ground making it relatively easy to place an axle on the cradle inserts 500 (see FIG. 1).

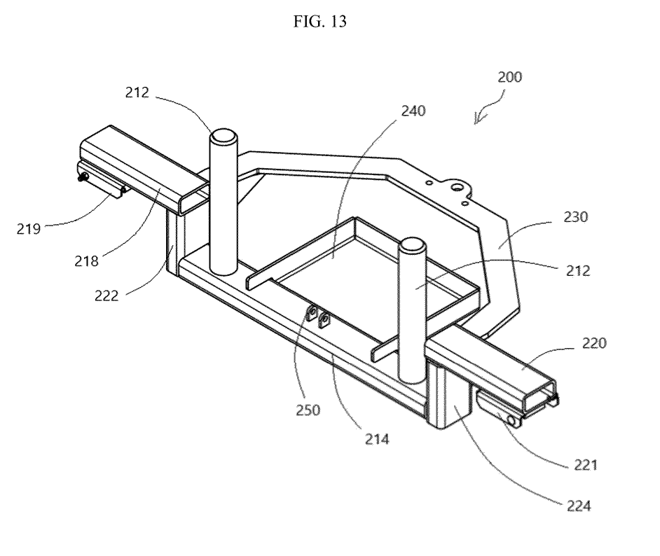

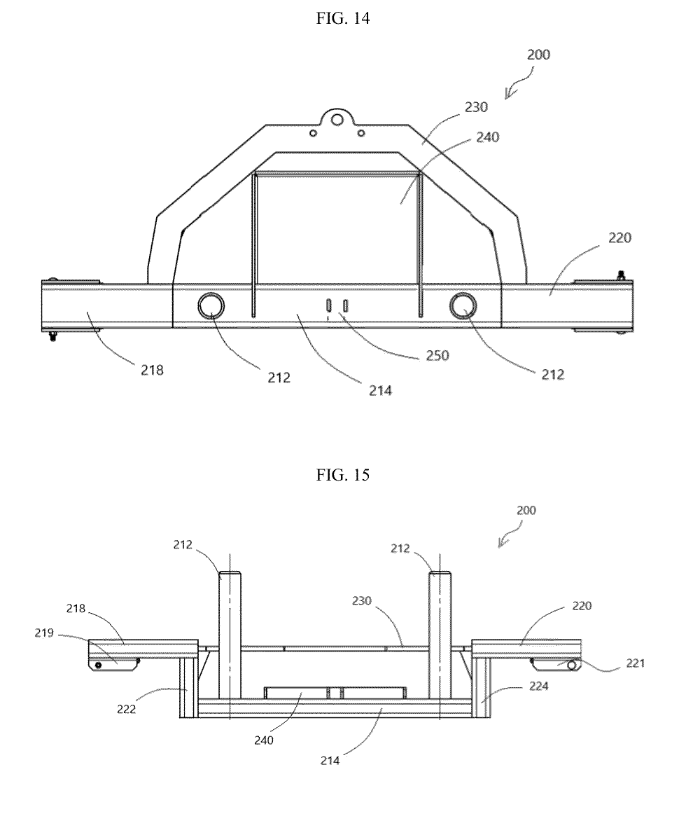

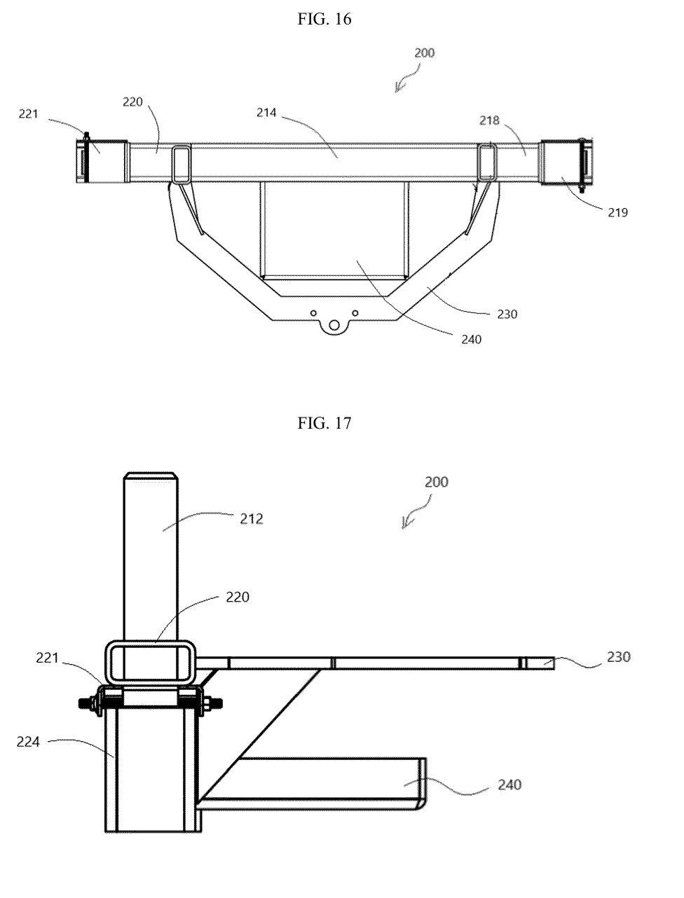

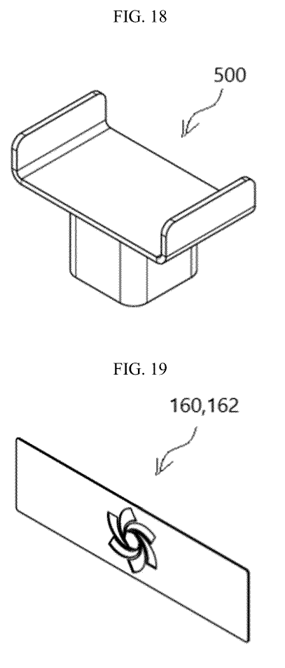

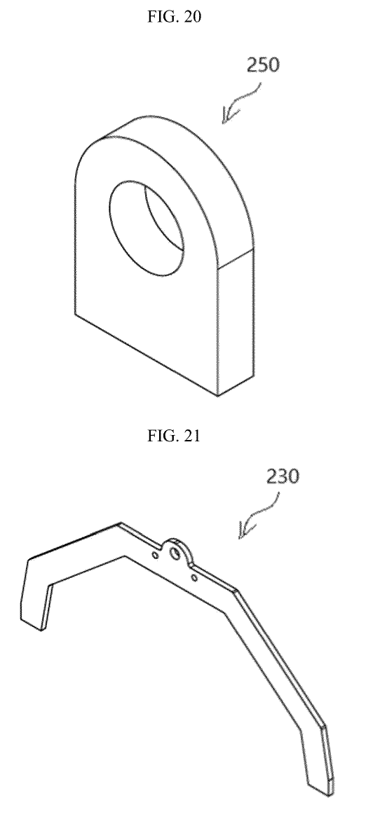

FIGS. 13-17 illustrate an example of a pusher lift cart subframe 200. The pusher lift cart subframe 200 may serve several functions. For example, it may provide a support for the power source 400 as well as a support for the actuator 300. To this end, the pusher lift cart subframe 200 may include a power source side plate 240 which may support the power source 400. In the nonlimiting example of FIGS. 13-17 the power source side plate 240 may be supported by a pusher lift cart subframe base member 214. The base member 214 may, in one embodiment, be made from a structural member, for example, tube steel, but may also be made from some other type of structural member, for example, an I, W, H, or C shaped member. So far as supporting the actuator 300, the base member 214 may include a pair of ears 250 (a close up shown in FIG. 20) which may facilitate a pin type connection for the actuator 300.

As shown in FIGS. 13-17, the example pusher lift cart subframe 200 includes the previously described complementary interfacing members 212 which may interface with the interfacing members 112 and/or 122. In the nonlimiting example of FIGS. 13-17, the complementary interfacing members 212 are supported on a base member 214.

The sides of the base member 214 of the pusher lift cart subframe 200, in one embodiment, include transition members 222 and 224 which connect the base member 214 to upper members 218 and 220. The upper members 218 and 220 may be made from tube steel, as shown in the figures, or some other type of structural member, for example, an I, W, H, or C shaped member, and the upper members 218 and 220 may include connections 219 and 221 to connect castor wheels 600 to the pusher lift cart subframe 200. For example, the connections 219 and 221 may be quick change bolt castor plates.

As shown in the figures, the base member 214 may be on a lower elevation that the upper members 218 and 220. This may allow the pusher lift cart main frame 100 to be moved closer to the ground than if the complementary interfacing members 212 were mounted on a structure having the same elevation as the upper members 218 and 220.

In example embodiments the pusher lift cart sub frame 200 may include a tow plate 230 which may interface with a forklift, tow motor, or other industrial device. For example, the tow plate 230 may include a hole 232 through which a pin may connect the tow plate 230 to the forklift, tow motor, or other industrial device.

Referring back to FIG. 1 and FIG. 6, when assembled the actuators 300 have one end connected to the base members 214 of the pusher lift cart subassemblies 200 via the ears 250 and another end connected to the pusher lift cart main frame 100 via the ears 149 and 159. In addition, the pusher lift cart main frame 100 and the pusher lift cart sub frames 200 are sliding connected to one another via the interfacing members 112, 122 and complementary interfacing members 212. When the actuators 300 are extended the interfacing members 112 and 122 slide along the complementary interfacing members 212 and the pusher lift cart main frame 100 moves upwards. When the actuators 300 are retracted the interfacing members 112 and 122 slide along the complementary interfacing members 212 and the pusher lift cart main frame 100 moves downwards. Because the actuators 300 may be operated independently, one end of the pusher lift cart main frame 100 may be moved upwards while the other end of the pusher lift cart main frame 100 may be moved downwards. In another situation, one end of the pusher lift cart main frame 100 may be moved upwards while the other end of the pusher lift cart main frame 100 does not move at all. In yet another situation, one end of the pusher lift cart main frame 100 may be moved upwards at a different rate than the other end of the pusher lift cart main frame 100. Of course, each of the actuators 300 may be controlled so that each end of the pusher lift cart main frame 100 raises and lowers at the same time.

Due to the profiles associated with the pusher lift cart main frame 100 and the pusher lift cart subframes 200 the axle support section can be moved very near, if not on, the ground. For example, the axle support section may be moved onto the ground, within about one inch of the ground, within about two inches above the ground, etc. Such an arrangement makes it relatively easy to move an axle on the cradles 500 of the pusher lift cart 1000.

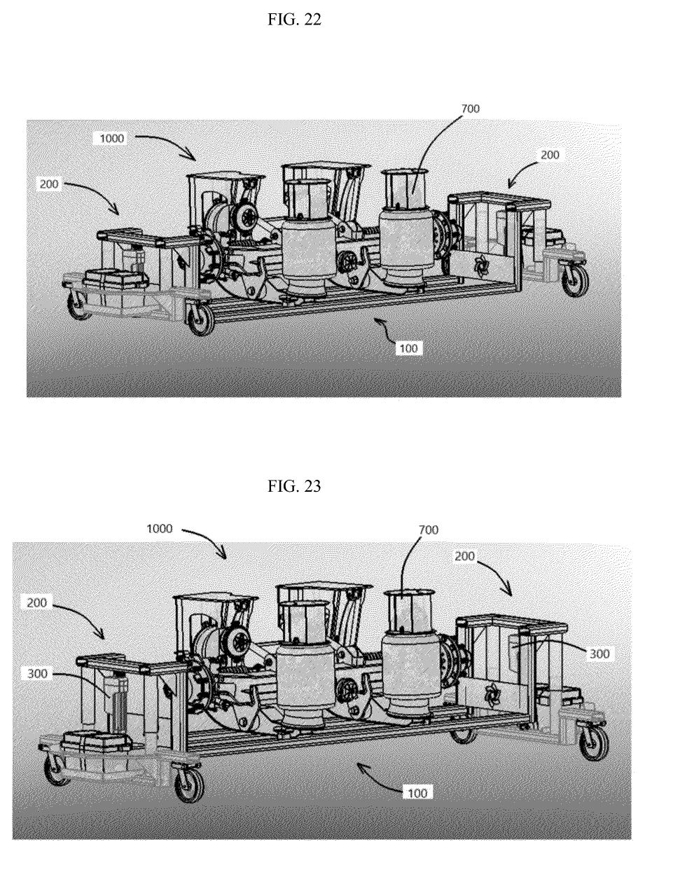

FIGS. 22 and 23 illustrate the pusher lift cart 1000 with an axle 700 supported thereon. In FIG. 22, the actuators 300 of the subframes 200 are somewhat retracted which allows the main frame 100 to be in a relatively low position. However, in example embodiments, when the actuators 300 extend, the main frame 100 is lifted upwards as shown in FIG. 23 allowing the axle 700 to be properly installed in a machine.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies.

What I claim is:

1. A pusher lift cart comprising:
a pusher lift cart main frame having first a first end and a second end, a first top section at the first end, a second top section at the second end, a first interfacing member on the first top section, a second interfacing member on the second top section, and an axle support section between the first top section and the second top section;
a first pusher lift cart sub frame at the first end of the pusher lift cart main frame, the first pusher lift cart subframe having a first complementary interfacing member telescopingly engaged with the first interfacing member; and
a second pusher lift cart sub frame at the second end of the pusher lift cart main frame, the second pusher lift car subframe having a second complementary interfacing member telescopingly engaged with the second interfacing member;
a first actuator connected to the first top section and the first pusher lift cart subframe; and
a second actuator connected to the second top section and the second pusher lift cart subframe, wherein the first end and the second end of the pusher lift cart main frame are moved upwards and downwards by the first and second actuators.

2. The pusher lift cart of claim 1, wherein the first top section includes a third interfacing member and the first pusher lift cart subframe includes a third complementary interfacing member telescopingly engaged with the third interfacing member.

3. The pusher lift car of claim 2, wherein the second top section includes a fourth interfacing member and the second pusher lift cart subframe includes a fourth complementary interfacing member telescopingly engaged with the fourth interfacing member.

4. The pusher lift cart of claim 1, wherein the first and second actuators are electrically powered linear actuators.

5. The pusher lift cart of claim 4, further comprising:
a first power source providing power to the first actuator; and
a second power source providing power to the second actuator.

6. The pusher lift cart of claim 1, further comprising:
a first wheel under the first pusher lift cart sub frame; and
a second wheel under the second pusher lift cart sub frame.

7. The pusher lift cart of claim 1, wherein the first and second actuators are configured to move the main frame onto the ground.

8. The pusher lift cart of claim 1, further comprising:
at least one tow plate configured to connect to an industrial device.

9. The pusher lift cart of claim 8, wherein the industrial device is one of a forklift and to motor.

10. The pusher lift cart of claim 1, wherein the first complementary interfacing member is configured to slide into the first interfacing member.
